(19) United States
(12) Patent Application Publication
(10) Pub. No.: US 2010/0223928 A1
(43) Pub. Date: Sep. 9, 2010

(54) Device for conversion of energy

(76) Inventor: Ralf Roppelt, Ludwigsburg (DE)

Correspondence Address: SHLESINGER, ARKWRIGHT & GARVEY LLP, 5845 Richmond Highway, Suite 415, ALEXANDRIA, VA, 22303, US

(21) Appl. No.: 12/656,420

(22) Filed: Jan. 28, 2010

Related U.S. Application Data
(63) Continuation of application No. PCT/EP2008/006357, filed on Aug. 1, 2008.

(30) Foreign Application Priority Data
Aug. 1, 2007 (DE) 10 2007 038 106.0

(51) Int. Cl. F03G 7/00; F03G 1/00

(52) U.S. Cl. 60/698; 60/721; 185/39

(57) ABSTRACT

The invention relates to a device for conversion of energy, to a module for storage of energy, and to a method for conversion and storage of energy, in which provision is made that at least one module, which is designed to store mechanical energy, is held in a number of holding stations of at least one device which is designed for conversion of energy, such that the least one module, which is held in one of the holding stations, is connected simultaneously via a transmission of the at least one device to a first energy converter and to a second energy converter, such that it is possible simultaneously to transfer energy from the first energy converter to the at least one module and to transfer energy from the at least one module to the second energy converter.

### RELATED APPLICATIONS

This is a continuation application of International PCT Application No. PCT/EP2008/006357, with an international filing date of Aug. 1, 2008, claiming the priority benefit of German Patent Application No. 10 2007 038 106.0, filed on Aug. 1, 2007, hereby incorporated by reference.

### FIELD OF THE INVENTION

The invention relates to a device for converting energy, a module for mechanical storage of energy, a method for converting and storing energy, a computer program, and a computer program product.

### BACKGROUND OF THE INVENTION

A drive system with mechanical battery for a motor vehicle is known from DE 29 06 563 A1, where the motor vehicle is driven by mechanical energy generated by a generator, stored and emitted. The generator comprises an hydraulic, pneumatic or mechanical charging device.

Furthermore, a mobile energy storage and energy supply device is known from the German utility model DE 202 20 148 U1. This device comprises several helical spring systems of which the helical springs can be tensioned and released using gear transmissions.

A device for storing energy to be decelerated from a torsion spring for re-use as propulsion mechanism for vehicles is known from DE 103 03 397 A1. The device has three switching positions which can be switched without clutch engagement and are arranged on an axle to be decelerated or driven.

Furthermore, a portable device for current generation is known from DE 196 11 816 A1. It is provided here that a helical spring can drive a current generator or dynamo using a suitable transmission ratio.

### SUMMARY OF THE INVENTION

Against the background of the stated prior art, a device, a module, a method, a computer program and a computer program product are presented.

The device in accordance with the invention is designed for converting energy and comprises the following components:
a number of accommodation stations, where one accommodation station each is designed for accommodating a module designed for storing mechanical energy;
two energy converters; and
a transmission designed to connect at least one module accommodated in one of the accommodation stations to a first energy converter and to a second energy converter such that it is possible to transmit energy at the same time from the first energy converter to the at least one module and from the at least one module to the second energy converter.

If several modules are accommodated in this device, it is possible to connect at the same time or with a time-lag at least one first module to the first energy converter and at least one second module to the second energy converter and to exchange energy between the modules and energy converters.

According to an embodiment, a transmission of the device can have two transmission branches, the first transmission branch being designed to connect the at least one module accommodated in the accommodation station to the first energy converter and the second transmission branch being designed to connect the at least one module accommodated in the accommodation station to the second energy converter. Hence one transmission branch of the transmissions in each case is suitable for providing a mechanical connection for transmitting energy between one energy converter and the module arranged or accommodated in one of the accommodation stations.

In the device, several modules transportable or portable independently of the device can be temporarily arranged in modular form.

A system for converting and storing energy can comprise several devices and several modules. This also results in the possibility to convert energy in a first device at a first location and to store it in a first module. As soon as a sufficient quantity of energy is stored in this first module, this module can be removed from an accommodation station of the first device and transported to a second device at a second location for discharging of the energy stored in the module. The module is then to be inserted into an accommodation station of the second device such that the energy stored in the module by conversion is discharged and hence released. As soon as there is no more energy stored in the module, it can be transported to the first device and recharged with mechanical energy. This procedure is ideal if, for example, a high solar irradiation prevails at the first location where the first device is located, such that the module is simply supplied with energy via the device. Furthermore, it is assumed in this example that a high energy requirement prevails at the second location, hence an energy transfer between the two locations is possible by using the two devices and one or more modules.

The accommodation stations are arranged one behind the other, such that a simultaneous charging and discharging of several modules is permitted, and switching between several modules to be charged with energy and/or discharged is designed efficiently.

In an embodiment, the first energy converter is designed to tension at least one mechanical energy reservoir, for example a spring, for example a helical spring, of the at least one module. The second energy converter is designed to release the at least one mechanical energy reservoir of the at least one module.

In this example, the first energy converter is designed as a motor and the second energy converter is designed as a generator, hence the energy converters are designed for converting mechanical energy into electrical energy and/or for converting electrical energy into mechanical energy.

In an embodiment, the transmission of the device is designed to switch between at least two modules such that one of the energy converters is connected initially to a first number of modules and, after performance of a switching operation, to a second number of modules. It is possible during operation of the device for the transmission to be connected to the at least one tension side of a module and at the same time to the at least one release side of this one module.

It is thus possible to switch back and forth between several modules during current operation of the device. This results in the possibility, depending on the quantity or capacity of the energy provided, to charge a suitable number of modules with mechanical energy such that the device can for example be automatically adapted to changing capacities. If during current operation at least one module has reached its charge capacity during a charging operation, this at least one module can be supplemented by switching of the transmission with at least one further module having a sufficient storage capacity for mechanical energy.

A similar situation also applies for a discharge operation to be performed. Depending on how much energy is required in each case, the at least one module can be connected via the transmission to the at least one second energy converter so that a quantity of energy required in the particular case is discharged. If energy of the at least one module is to be completely discharged, this module can be disengaged from the at least one second energy converter by performing the switching operation using the transmission and re-engaged to the first energy converter. Modules in which a sufficient quantity of energy is stored can be engaged with the second energy converter and discharged by performing the switching operation using the transmission.

In the device, the transmission and in particular the first transmission branch may comprise a first main shaft for connecting the first energy converter to the tension side of the at least one module. The second transmission branch of the transmission may comprise a second main shaft for connecting the second energy converter to the release side of the at least one module.

In an embodiment, the transmission can for example be designed as a chain transmission and have at least one chain gear for performance of the switching operation for mechanical engagement or disengagement of the tension side or release side of the at least one module.

In addition, the transmission may on a first side or charging side of each accommodation station comprise an internal gear ring brake, a shift hub, an actuator and a ratchet wheel, where the ratchet wheel is designed for continuous securing of an energy transmission and where the at least one tension side of the at least one module is arranged on this first side from where this accommodated module is to be charged with energy. Furthermore, the at least one internal gear ring brake may comprise a motor-operated clutch.

Furthermore, the transmission of the device may comprise on a second side or discharge side of each accommodation station an internal gear ring brake, a freewheel, a shift hub, an actuator and a drive shaft, the at least one release side of at least one module being arranged on this second side from where the at least one accommodated module is to be discharged.

Further, the device comprises for each module to be held on the at least one tension side and/or release side at least one freewheel module, such that it is possible to mechanically disengage the at least one tension side from the at least one release side.

Overall, the first energy converter, for example a motor, is designed to transmit energy provided from the outside via the first transmission branch to the at least one module so that this energy is to be stored in the at least one module. The second energy converter, for example a generator, is designed to emit to the outside energy stored in the at least one module via the second transmission branch. Charging and discharging of the at least one module with energy can be performed at the same time or with a time lag.

In an embodiment, the device comprises an electronic and/or automatic checking device, or open-loop and/or closed-loop control device for checking and hence for open-loop and/or closed-loop control. Using the checking device, the transmission is checked or actuated, such that depending on the operating situation of the device a suitable number of modules is charged with energy and/or discharged.

Additionally, the device may comprise at least one brake generator.

The device is designed to transmit naturally provided energy to the at least one module accommodated in an accommodation station and to make it available again at a later time.

The naturally provided energy is typically energy from natural and renewable resources, wherein such energy can be provided due to weather phenomena or weather effects such as wind and/or solar irradiation. Accordingly, the device can be designed to transmit energy coming from a photovoltaic system to the at least one module accommodated in one of the accommodation stations. Furthermore, the device can be designed to transmit energy provided by a wind energy system to the at least one module accommodated in one of the accommodation stations.

The module in accordance with the invention comprises at least one mechanical energy reservoir plus at least one tension side and at least one release side. Energy is here supplied to the at least one energy reservoir via the at least one tension side. Energy stored in the at least one energy reservoir is withdrawn via the at least one release side.

The mechanical energy reservoir is designed as a spring, for example as a helical spring. The module is accordingly designed as a mechanical battery. This spring or helical spring has a tension side and a release side. For example, the central end of the helical spring can be designed as the tension side and the outer end of the helical spring as the release side. Alternatively, the central end can also be designed as the release side and the outer end of this helical spring as the tension side.

This module is suitable for being accommodated in a device such that one tension side can be connected to a first energy converter and if necessary a release side can be connected to a second energy converter at the same time or with a time-lag.

In an embodiment, the module comprises on the at least one tension side a tension wheel designed as the main tension wheel and on the at least one release side a tension wheel designed as the main release wheel. The main tension wheel can be mechanically engaged with the tension shaft or disengaged. In the same way, the main release wheel can be mechanically engaged with the release shaft or disengaged.

The module can be accommodated in an accommodation station of at least one previously described device for converting energy and connected via a first transmission branch on the at least one tension side to a first energy converter and in an embodiment at the same time via a second transmission branch on the at least one release side to a second energy converter, such that it is possible to transmit energy from the first energy converter to the module and from the module to the second energy converter. A transmission of energy between various devices is feasible by transporting a module in which mechanical energy is stored from a first device to a second device. In a further embodiment, the charge side of the accommodation station is assigned to the first transmission branch and the discharge side of the accommodation station to the second transmission branch.

The result is that for charging of the module the tension side interacts with the first transmission branch. For discharging the module, the release side of the module interacts with the second transmission branch. To do so, it is provided that the first main shaft of the device is mechanically connected to the tension shaft of the module and hence to the at least one tension side of the module and hence to engage them. The second main shaft of the device is to be mechanically connected to the release shaft and hence to the at least one release side of the module and hence engaged.

The module is designed transportable and for storing mechanical energy and, for conversion of the mechanical energy, is to be temporarily arranged and accordingly accommodated in an accommodation station of at least one device designed for converting mechanical energy. With the module, it is possible to transport energy between several devices located at different places.

The invention also relates to a method for converting and storing energy, wherein at least one module for storing mechanical energy is accommodated in at least one accommodation station of at least one device designed for converting energy, such that via a transmission of the at least one device for converting energy at least one module accommodated in the at least one accommodation station is connected to a first energy converter and to a second energy converter such that it is possible for energy to be transmitted simultaneously from the first energy converter to the at least one module and from the at least one module to the second energy converter.

Due to the method and to the at least one device and/or to the at least one module, an environmentally friendly provision of energy generated for example by weather phenomena such as solar irradiation and/or wind is possible. The energy thereby generated can be mechanically stored in the at least one module after conversion by the device for any required period with low losses, and released again depending on requirements.

A supply of solar energy usually depends on a solar irradiation that can vary over the course of a day. The same applies to wind energy, which can also vary depending on the time of the day. The device can by tensioning of at least one module store energy therein when the stated energy sources are available. A release of the at least one module and hence a withdrawal of the stored energy therefrom can be done at any time required. This makes it possible for solar energy to be stored as mechanical energy during the day in the at least one module and for this stored energy to be withdrawn from the at least one module and converted to electrical energy as soon as it is required, for example overnight.

The principle presented in the framework of the invention provides, among others, the possibility of prolonging the charging and discharging times of a module. Several modules can be arranged one behind the other in a device at the same time. These modules can be switched on as required, such that it is possible to supply energy to at least one first module and to withdraw energy from at least one second module. Using the mechanical storage devices of the modules typically designed as helical springs, it is possible, depending on how many modules are connected to the transmission of the device for supply and/or withdrawal of energy, to vary the torque, i.e. increase or reduce it. It is furthermore possible, depending on how many modules are mechanically connected to the transmission, to vary the speed of the mechanical storage devices of the modules.

For the invention presented, different possible uses can be imagined. For example, the invention is suitable for decentralised power supply or uninterruptible power supply (UPS) in electronic data processing. Thanks to the flexible handling of energy also made possible with the invention, load equalization with the power mains is possible. The presented device can also be used as a charging station for an electric car or as a power reservoir in combined heat and power (CHP).

The described invention can for example be used for a three-person family as a decentralized power supply. The annual consumption of the family is approx. 3,500 to 4,500 kWh, so that a daily average consumption of energy is approximately 11 kWh. Per hour this is about 450 W. The invention can for example be operated with a photovoltaic system. With normal solar irradiation, the monthly yield of the photovoltaic system during the spring in Central Europe is around 510 kWh, so that an average daily yield amounts to around 17 kWh, corresponding to a capacity of 700 W/h. From this it derives that a 5 kW photovoltaic system can provide even in spring about 150% of the required energy. Against the background of the energy requirement of the family, an energy reservoir would have to attain a continuous capacity of about 450 W. It would accordingly be necessary for the energy reservoir to bridge a period of at least 14 hours unless additional energy sources are to be provided. By provision of a suitable number of described modules, superfluous solar energy provided by the photovoltaic system can be stored and not withdrawn until required.

Within the framework of the invention, use as a UPS (uninterruptible power supply) is likewise possible. Here at least one mechanical energy reservoir or at least one spring reservoir of at least one module running under continuous load can be switched within a few milliseconds to the power mains, with recovery of the stored or generated energy.

If the invention is applied to an electric car, the required energy quantities of the electric car can be transmitted in a short time into a battery. It is provided here, for example, that a 45 kW/h lithium-ion battery of an electric car requires about 12 hours for charging from the power mains. For rapid charging for example within one hour, the charge would have to be provided with a voltage of 400 V and a current of 112 A. This capacity is readily available in case of appropriate design of the mechanical storage device or of the spring reservoir. The energy provided here for the electric car can also be provided from regenerative energy sources and hence CO₂-free.

In the case of a combined heat and power (CHP) system, the maximum efficiency to be achieved is usually only in the case of priority operation for hot water. Since however current always has to be available for stand-alone operation, a CHP system as a rule is uneconomical to operate in the summer. With the application of the described invention, a significant increase in the efficiency can be achieved by the CHP system starting up only when heat is required and by the current produced during this time being stored in at least one spring reservoir of at least one module in accordance with the invention.

Furthermore, it is also possible with the invention to provide a load equalization in the power mains. As a result, a sustainable energy supply can be achieved. Short-term clouding of the sun or lulls in the wind can be equalized using the at least one energy reservoir device of the at least one module. In addition, a provision of energy into the power mains to suit requirements is possible. Depending on the expansion stage of the at least one spring reservoir of the at least one module, a constant capacity can be fed into the power mains over a lengthy period of several hours.

The described invention has a wide range of uses and can be expanded. The at least one storage device of the at least one module is for example made of steel or another suitable mechanically formable material. The module is thus durable, temperature-insensitive and completely recyclable or biodegradable. The module typically comprises non-hazardous raw materials.

Conventional electric batteries are temperature-sensitive regardless of their design. Temperatures around freezing point and temperatures above 50° C. can cause irreversible damage in most batteries. By contrast, the spring reservoir, usually made from a metal such as steel, of a module can also be used well below 0° C. and well above 80° C.

Charge voltages for conventional electric batteries may typically only vary by one to two percent and must be continually adjusted depending on the outside temperature. The spring reservoir of a module can by contrast be connected without regulation directly to photovoltaic modules or to a wind generator for transmission of energy. Furthermore, a maximum capacity of the module can be made available several times, whereas a maximum capacity of an electric battery is usually only available once. The service life of electric batteries depends on the already cited factors. It is however necessary to continually monitor and adjust for climatic conditions, for example, in the surroundings of the electric battery. In the case of the module in accordance with the invention with a mechanical energy reservoir or spring reservoir, a substantially longer life can be achieved. In addition, the module can be operated independently of climatic conditions.

The computer program, additionally provided in accordance with the invention with program code means, is designed to perform all the steps of a described method for automatic checking of a transmission and/or of a state of at least one module when the computer program is run on a computer or a corresponding calculation unit, in particular in a described device.

The invention furthermore relates to a computer program product with program code means stored on a computer-readable data carrier to perform all the steps of a described method for automatic checking of a transmission and/or of a state of at least one module when the computer program is run on a computer or a corresponding calculation unit, in particular in an arrangement in accordance with the invention.

The calculation unit of the device can be designed as a component of the checking device of the device or interact with such a checking device. The checking device and/or the calculation unit of the device are, as already described, designed to check the transmission of the device during operation and hence to exert open-loop and/or closed-loop control. The calculation unit and/or the checking device can, alternatively or supplementarily, also check a state of at least one of the modules and hence monitor it, such that it is possible to trace during operation how much energy is mechanically stored in a respective module. Depending on the state of a respective module, it can be connected electronically and/or automatically via one of the transmission branches to the first energy converter or to the second energy converter or disconnected therefrom.

The combination of the devices and the modules in a complete system has a high degree of efficiency. The charge of one of the springs is available not only above a certain capacity. The spring can, thanks to a design of the transmission, be charged via the device even with a low yield from the solar energy collectors.

One advantage over electric batteries and input systems is that in such batteries and input systems energy can only be supplied in when the available solar power is above a predetermined charge voltage or the converter voltage. In addition, with one variant of the present invention substantially more power can be withdrawn than was available for charging.

The invention is of very simple design with long-term stability. No losses occur due to friction or temperature fluctuations. Furthermore, the invention is sustainable and of major ecological benefit, with a CO₂-free energy conversion being possible.

The basis of a running time calculation for a discharge of a spring of the module is a maximum number of windings in a spring casing of the module in which the spring or helical spring is arranged. This is, taking into account the spring thickness and the diameter, i.e. an internal diameter of a hub and the spring casing of the module, 30 revolutions per hour or 0.5 rpm.

With a total transmission ratio of, for example, i=202, the resultant speed at the generator is 100 rpm. This speed is available for a capacity of around 500 W. If less capacity is needed, the speed drops and the running time is extended. In a normal household, a capacity of 250 to 1000 W is needed. This would almost double the running time of a spring.

The calculation of the torques is only approximately possible and depends on many factors. Specialist literature always assumes, in the case of helical springs, tests to ascertain the actually occurring forces. In all calculations, the spring strip width is considered either not at all or only very imprecisely in the calculations.

The charging of a spring of the module is performed reciprocally in the embodiment. Furthermore, a calculation of energy to be supplied depends heavily on the capacity and on the design as an input system or stand-alone system, and on an efficiency of solar panels of a photovoltaic system. The calculation performed relates to a stand-alone system which has to provide a 1,500 W capacity at maximum yield. It can only be ascertained by testing the capacity from and above which the generator can already be driven, hence only the ideal condition can be calculated beforehand. For solar panels with a capacity of 165 W, ten such solar panels are required, for example.

Since this energy reservoir technology is not available on the market in this form, an estimate of the anticipated number of units sold is only possible by comparisons with existing technologies.

Use of the spring motor and hence of the module is for example possible in a stand-alone system in combination with photovoltaic collectors or wind systems in order to achieve, by appropriate dimensioning, a completely self-contained power supply. In this case, applications for detached houses, for developing countries (emerging economies), for research stations and/or self-contained weather stations are conceivable. In agriculture, pumps can be supplied. For solar input systems, a uniform load distribution can be achieved and the effectiveness increased. In this way, peak capacities can be spread out to later times. Solar current can be better calculated thanks to the uniform input.

Furthermore, there is relief for voltage peaks from the power mains, as for example with an emergency power generator—for example in hospitals and public buildings. It is also possible to provide a so-called UPS, i.e. uninterruptible power supply, for servers and computer systems.

One aspect for a development of the spring motor of a module is the availability of very slow-running DC generators typically provided for small wind farms. These are specially designed to start with a low torque. They have very good bearings and an efficient cooling system. The usable speed range includes a further interval. They supply high power even with a speed of about 100 rpm and up to more than 700 rpm.

To achieve the lowest possible friction losses during charging and discharging of the spring, a transmission designed as a chain transmission is selected, where individual transmission branches of the transmission can likewise be designed as chain transmissions. Since very high speeds are not generated, there is no need to expect high wear and high temperatures. On the tension side or on the release side, a ratchet wheel is used for continuous securing. In addition, a locking system is installed by an internal gear ring with a motor-operated clutch. The main shaft is connected to the transmission and in particular to a transmission branch of the device via a freewheel. The release side and the tension side are usually identical except for the ratchet wheel.

A capacity-dependent speed control is not as a rule integrated, since no precise torque calculations are necessary. There are several possibilities for the design. It would be for example conceivable to use a kind of derailleur gear as for a bicycle, in order to divert in this way the resultant forces back to the tension mechanism of the spring and in so doing regulating the speed. As a rule, the control can be achieved electronically via the checking device. To do so, the necessary withdrawn power is measured and an appropriate gear ratio of a transmission branch is set.

Further advantages and embodiments of the invention are shown in the description and the attached drawing.

It is understood that the aforementioned features and those still to be explained in the following can be used not only in the combination stated in each case, but also in other combinations or singly, without going beyond the scope of the present invention.

### BRIEF DESCRIPTION OF THE DRAWINGS

FIG. 1 shows in a schematic view a first embodiment of a device in accordance with the invention, with first embodiments of modules in accordance with the invention accommodated therein.

FIG. 2 shows in a schematic view a front view of a transmission of a second embodiment of a device in accordance with the invention.

FIG. 3 shows a first schematic view of a section of a transmission of a third embodiment of a device in accordance with the invention, with third embodiments of modules in accordance with the invention accommodated therein.

FIG. 4 shows the arrangement from FIG. 3 from a second perspective.

FIG. 5 shows in a schematic view a section of a transmission of a fourth embodiment of a device in accordance with the invention, with fourth embodiments of modules in accordance with the invention accommodated therein.

FIG. 6 shows in a schematic view fifth embodiments of devices and modules in accordance with the invention.

FIG. 7 shows in a schematic view details of a sixth embodiment of a module.

FIGS. 8a and 8b shows in a schematic view details of a seventh embodiment of a module.

### DETAILED DESCRIPTION OF THE DRAWINGS

The invention is schematically illustrated on the basis of design examples in the drawing and is described in detail in the following with reference to the drawing.

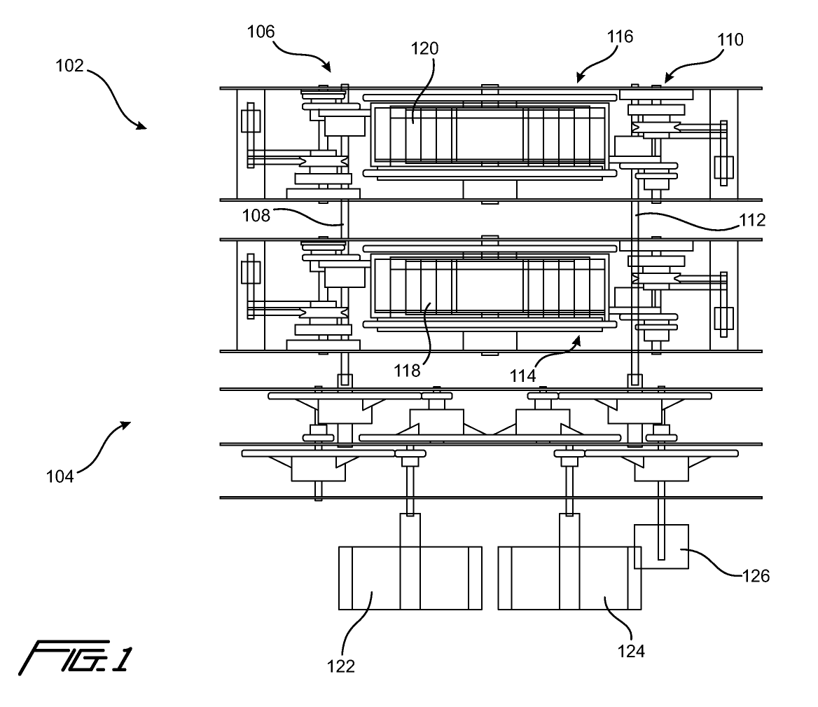

The device 102 in accordance with the invention shown schematically in a first embodiment in FIG. 1 comprises a transmission designed as a chain transmission 104 with a first transmission branch 106 that comprises a main shaft 108, and a second transmission branch 110 that comprises a second main shaft 112. Furthermore, this embodiment comprises a first and a second accommodation station 114, 116, in which in each case a module 118, 120 designed for storing of mechanical energy is arranged. It is furthermore provided that the device 102 schematically illustrated in FIG. 1 comprises a first energy converter 122 designed as a charge generator, a second energy converter 124 designed as a discharge generator and a brake generator 126.

During operation of the device 102, it is provided that the first energy converter 122 designed as a charge generator is driven and hence set in rotation by an external energy source. By suitable switching of the transmission, rotation energy is transmitted to at least one of the modules 118, 120, in this case the first module 118, via the first main shaft 108 of the first transmission branch 106, and hence the mechanical energy reservoir arranged in the at least one module 118, 120 is charged with energy. At the same time, it is provided that the at least one module 118, 120, in this case the second module 120, is discharged, such that the second main shaft 112 extending from the discharging energy reservoir of the at least one module 118, 120 is set in rotation, and hence rotation energy is transmitted via the second transmission branch 110 to the second energy converter 124. This mechanical energy is here re-converted into electrical energy in the second energy converter 124 and supplied to an external energy consumer. For mechanical connection of the modules 118, 120 to the transmission branches 106, 110, it is provided that chains loop on the one hand around gear wheels of the main shafts 108, 112 and on the other hand around tension wheels, here too designed as gear wheels, of the modules 118, 120, such that rotation movements between the modules 118, 120 and the main shafts 108, 112 are transmitted via the chains.

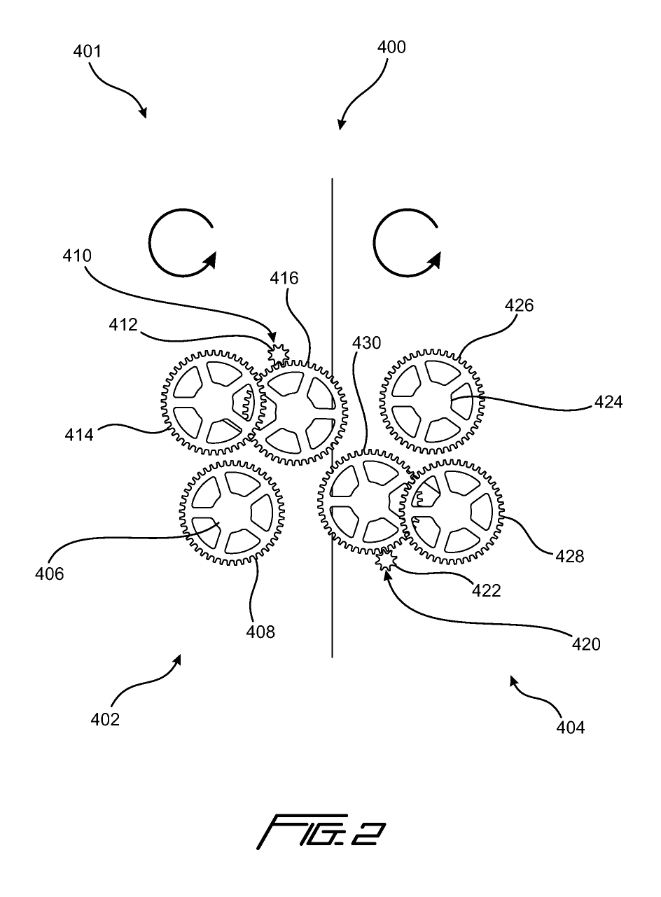

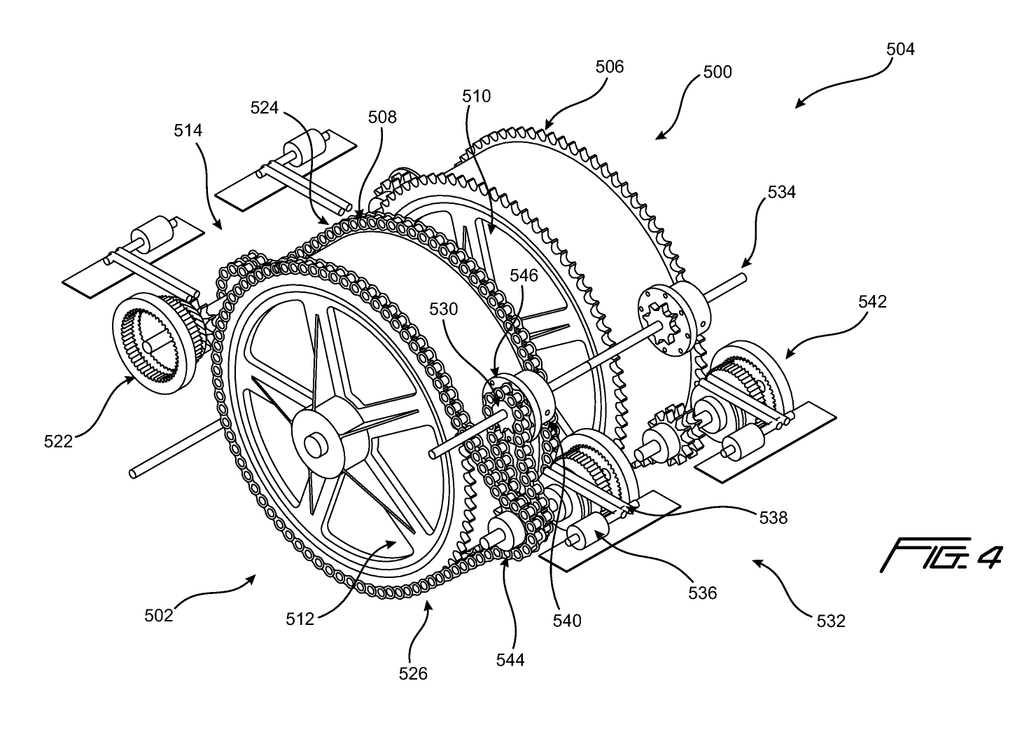

The schematic illustration shown in FIG. 2 of a second embodiment of a transmission 400 of a device 401 in a front view has on the left-hand side individual components of a first transmission branch 402 and on the right-hand side individual components of a second transmission branch 404. The first transmission branch 402 here has a first main shaft 406 with a gear wheel 408, this first main shaft 406 being connected to all modules not shown in detail in FIG. 4 and arranged in accommodation stations of the device 401. Furthermore, a drive shaft 410 is shown on the left-hand side with a gear wheel 412 that meshes with further gear wheels 414, 416 of the first transmission branch 402, such that the first main shaft 406 is set in rotation via the gear wheels 408, 412, 414, 416 extending from the drive shaft 410 of the first transmission branch 402.

On the right-hand side, FIG. 2 shows a drive shaft 420 of a generator with a gear wheel 422 arranged on it. The right-hand transmission branch 404 of the device 401 furthermore comprises a second main shaft 424 with a gear wheel rotatably connected via a release side to a module, not shown in detail, and further gear wheels 428, 430, via which rotation energy originating from the at least one module is transmitted via the second main shaft 424 to the drive shaft 420 of the generator.

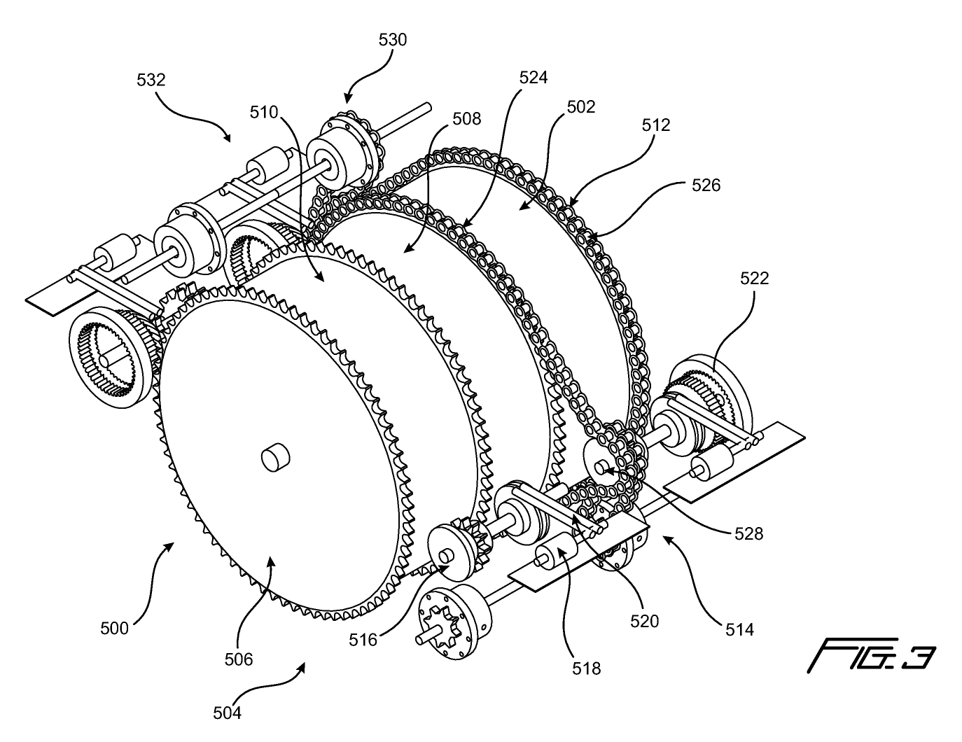

FIG. 3 shows from a first perspective third embodiments of modules 500, 502, where in each case one of these modules 500, 502 is arranged in an accommodation station of a third embodiment of a device 504 for energy conversion in accordance with the invention. Each module 500, 502 comprises here a main tension wheel 506, 508 and a main release wheel 510, 512. The view shown in FIG. 3 shows in the foreground a section from a first transmission branch 514 of the device 504 on a tension side of the modules 500, 502. This section of the first transmission branch 514 comprises a ratchet wheel 516, an actuator 518, a shift hub 520 and an internal gear ring brake 522. Furthermore, FIG. 3 shows a first chain 524 and a second chain 526. The first chain 524 here loops around the main tension wheel 508 of the second module 502 on the one hand and around a drive wheel 528 of the first transmission branch 514 on the other hand. The second chain 526 loops around the main release wheel 512 of the second module 502 and around a driven wheel 530 of a second transmission branch 532 of the device 504.

With this arrangement, it is possible to transmit, via the first transmission branch 514, energy provided by a first energy converter designed as a motor as rotation energy provided and converted from electrical energy via the first chain 524 on the tension side to the second module 502, and thereby tension a mechanical storage device of this second module 502.

Furthermore, the storage device of the second module 502 is to be released by the main release wheel 512 and the driven wheel 530. It is possible here to mechanically connect a tension side of the storage device to the main tension wheel 506 and hence to both engage and disengage it. Furthermore, it is if required also possible at the same time to mechanically connect a release side of the storage device to the main release wheel 512 and hence to both engage and disengage it. If a mechanical connection has been made to the tension side, the storage device can be tensioned via the first transmission branch 514, the drive wheel 528, the main tension wheel 506 and the tension side. If a mechanical connection has been made to the release side, the storage device can be released via the second transmission branch 532, the driven wheel 530, the main release wheel 512 and the release side.

FIG. 4 shows from the rear the device 504 with the modules 500, 502 from FIG. 3. The second transmission branch 532 shown here furthermore comprises a drive shaft 534, an actuator 536, a shift hub 538, a freewheel 540 and an internal gear ring brake 542. It is provided that the second chain 526 loops around the main release wheel 512 of the second module 502 and a gear wheel 544 of the second transmission branch 532. A third chain 546 loops around the driven wheel 530 and the gear wheel 544, such that the gear wheel 544 is rotatably connected to the driven wheel 530 of the freewheel 540. The freewheel 540 is firmly connected to the driven wheel 530 for disengaging the spring. The force of the spring of the second module 502 is transmitted to the main or drive shaft of the release side.

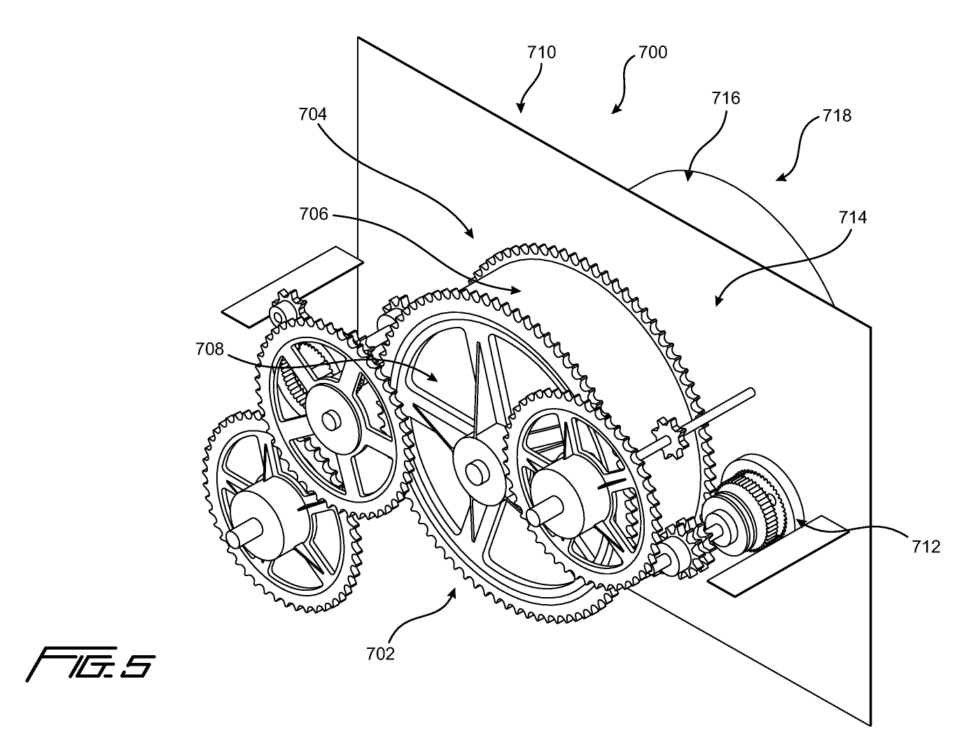

FIG. 5 shows in a schematic view a fourth embodiment of a module 700 designed for storing of mechanical energy and arranged in an accommodation station 702 of an only partially illustrated embodiment of a device. FIG. 5 furthermore shows a main tension wheel 704, an energy reservoir 706 of the module 700 designed as a spring, and a main release wheel 708 of this module 700. Furthermore, FIG. 5 shows components of a transmission 710 of the device, i.e. a locking means 712 and a segment wall 714 by which the first module 700 shown here is separated from a second module 716 only partially shown, where the first accommodation station 702 for the first module 700 too is separated by the segment wall 714 from a second accommodation station 718 for the second module 716.

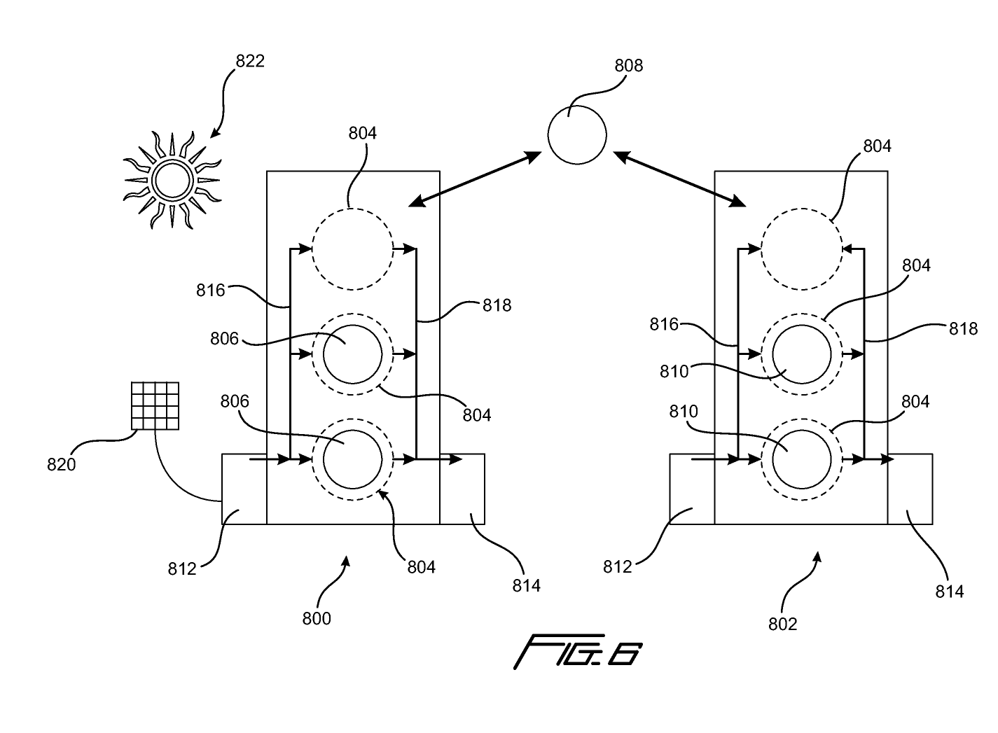

FIG. 6 shows in a schematic view two fifth embodiments of devices 800, 802 in accordance with the invention, which each have three accommodation stations 804 for holding fifth embodiments of modules 806, 808, 810, designed for storing of mechanical energy. Furthermore, each device 800, 802 from FIG. 6 comprises a first energy converter 812 designed as a motor and a second energy converter 814 designed as a generator. In addition, a first transmission branch 816 and a second transmission branch 818 are provided for each device 800, 802.

Via the first transmission branch 816, modules 806, 808, 810 arranged in the accommodation stations 804 can be charged with mechanical energy originating from the first energy converters 812. To do so, a tension side of a module 806, 808, 810 is in each case to be mechanically connected to the first transmission branch 816, such that a mechanical storage device of each of the modules 806, 808, 810 is tensioned via the tension side.

Mechanical energy stored in the modules 806, 808, 810 can be discharged via the second transmission branches 818 and supplied to the second energy converters 814 and converted into electrical energy. In each case, one module 806, 808, 810 is mechanically connected via a tension side to the second transmission branch 818, such that a mechanical storage device of a module 806, 808, 810 is released via the tension side.

In the present embodiment, a first main shaft, not shown in detail, of the first transmission branches 816 is set in rotation by the first energy converters 812. Chains looping around gear wheels of these first main shafts and main tension wheels of the modules 806, 808, 810 transmit this rotation energy to the tension sides of the modules 806, 808, 810. During the discharge of energy from the modules 806, 808, 810, chains looping around the main release wheels of the modules 806, 808, 810 and gear wheels of second main shafts of the second transmission branches 818 also transmit rotation energy originating from the release sides. The first device 800 shown on the left-hand side is connected to a photovoltaic system 820 designed to convert energy from the sun 822 into electrical energy.

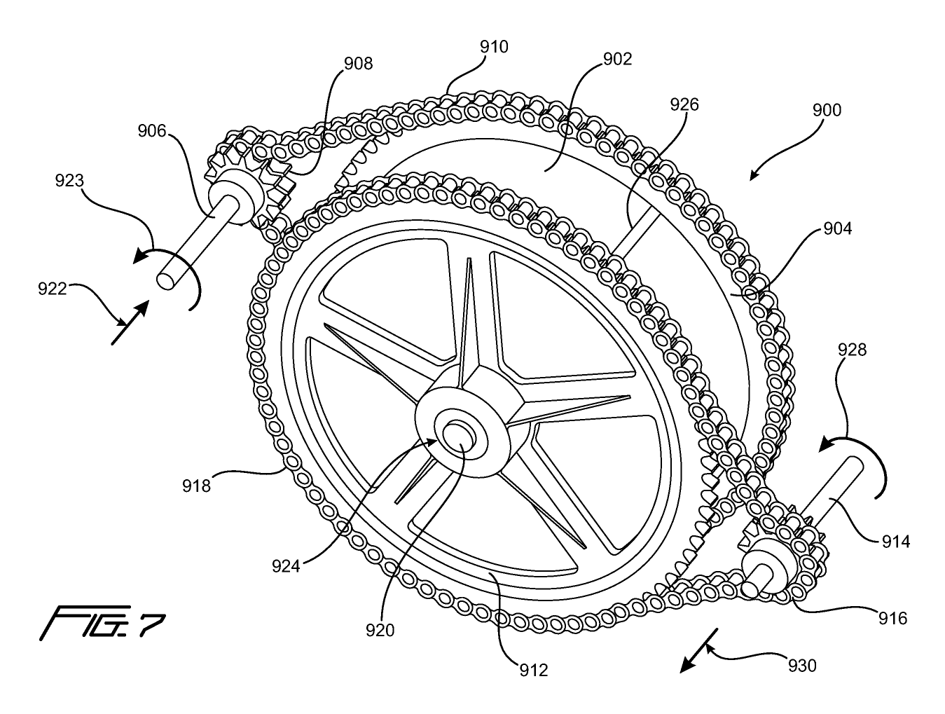

FIG. 7 shows in a schematic view a sixth embodiment of a module 900 in accordance with the invention with a mechanical energy reservoir 902 designed as a helical spring, a main tension wheel 904, a tension shaft 906 with a tension wheel 908 and a first chain 910 looping around the main tension wheel 904 and the tension wheel 908, a main release wheel 912 and a release shaft 914 with a release wheel 916. A second chain 918 loops around the main release wheel 912 and the release wheel 916. If the energy reservoir 902 is supplied with energy, the energy supply 922 comes from outside. The tension shaft 906 and the tension wheel 908 are here set in rotation 923.

The module 900 shown here furthermore has a ball bearing 924 by which the main release wheel 912 is mechanically disengaged from the central shaft 920. It is thus possible that the main tension wheel 904 and the main release wheel 912 can rotate independently of one another in different directions and at different speeds.

For withdrawing energy, a release side 926 of the energy reservoir 902 is temporarily connected to the main release wheel 912 such that the release wheel 916 and the release shaft 914 are set in rotation 928 and an energy withdrawal 930 from the helical spring takes place.

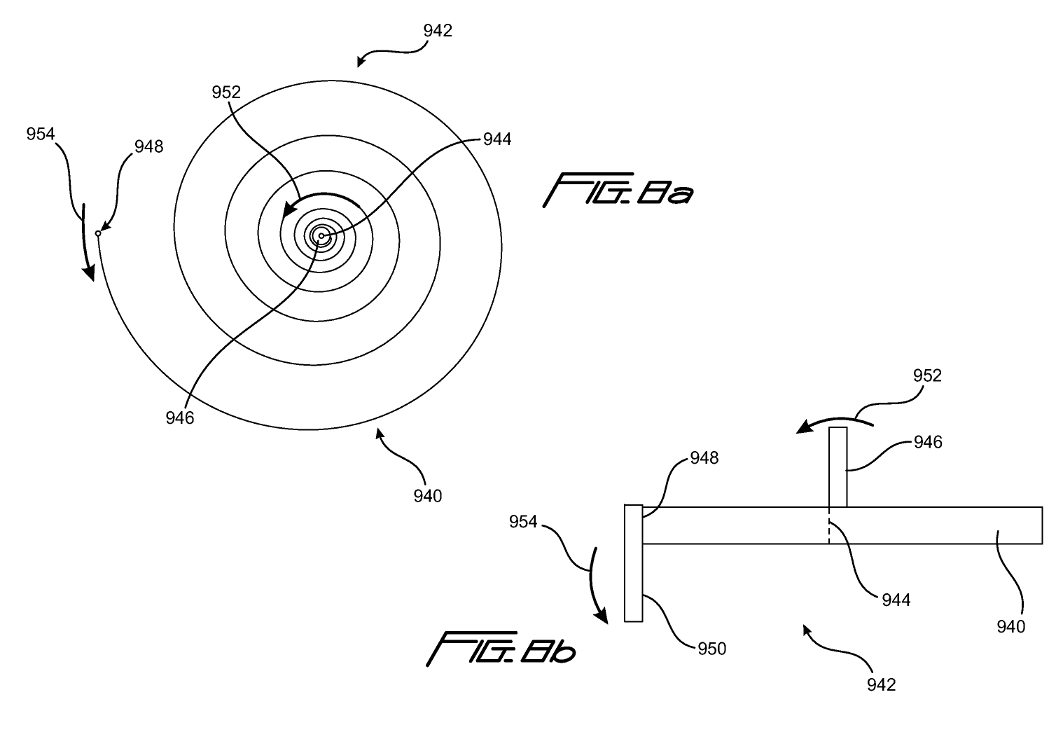

FIG. 8a shows a mechanical energy reservoir 940 designed as a helical spring of a seventh embodiment of a module 942 in accordance with the invention from the side in a schematic view. FIG. 10b shows this energy reservoir 940 in a schematic view from above. An inner or central end of the energy reservoir 940 is designed in the present embodiment as the tension side 944. This tension side 944 is mechanically connected to a central shaft 946 of the module 942. In addition, an outside or non-central end of the energy reservoir 940 is designed as the release side 948. This release side 948 can be connected via a mechanical connecting element 950 to a main release wheel, not shown here, of the module 942.

During operation of the module 942, it is provided, in order to supply energy into the energy reservoir 942, that the central shaft 946 is set in rotation and hence the storage device 940 is tensioned via the tension side 944 (arrow 952). For emission of energy from the energy reservoir 940, it is provided that the latter is released via the release side 948, where mechanical energy is released (arrow 954) via the release side 948 connected to the main release wheel by the mechanical connecting element.

It is possible by a suitable mechanical connection or coupling of the tension side 944 and/or of the release side 948 of the energy reservoir 940, to simultaneously both tension and release the energy reservoir 940 designed here as a helical spring. In the present embodiment, the energy reservoir 940 is thus tensioned via the tension side 944 from the centre and released via the release side 948 from the outside, where the energy reservoir 940 designed as a helical spring can be tensioned and released at the same time.

I claim:

1. A device for converting energy, comprising:
a number of accommodation stations, where one accommodation station each is designed for accommodating a module designed for storing mechanical energy;
two energy converters; and
a transmission designed to connect at least one module accommodated in one of the accommodation stations to a first energy converter and to a second energy converter such that it is possible to transmit energy at the same time from the first energy converter to the at least one module and from the at least one module to the second energy converter.

2. The device according to claim 1, wherein the transmission has two transmission branches, the first transmission branch being designed to connect the at least one module accommodated in the accommodation station to the first energy converter, and the second transmission branch being designed to connect the at least one module accommodated in the accommodation station to the second energy converter.

3. The device according to claim 1, wherein the first energy converter is to be connected to at least one tension side of the at least one module accommodated in the accommodation station and the second energy converter is to be connected to at least one release side of the at least one module accommodated in the accommodation stations.

4. The device according to claim 1, wherein the accommodation stations are arranged one behind the other.

5. The device according to claim 1, wherein the first energy converter is designed as a motor and the second energy converter as a generator.

6. The device according to claim 1, wherein the transmission is designed to switch between at least two modules accommodated in accommodation stations such that at least one of the energy converters is connected initially to a first number of modules and after performance of a switching operation to a second number of modules.

7. The device according to of claim 3, wherein the transmission has a first main shaft for connecting the first energy converter to the at least one tension side of the at least one module and a second main shaft for connecting the second energy converter to the at least one release side of the at least one module.

8. The device according to claim 1, wherein the transmission is designed as a chain transmission and comprises at least one derailleur gear or chain connection.

9. The device according to claim 1, wherein the transmission comprises, on a first side of each accommodation station from which an accommodated module is to be charged with energy, an internal gear ring brake, a shift hub, an actuator and a ratchet wheel.

10. The device according to claim 1, wherein the transmission comprises, on a second side of each accommodation station from which energy is to be discharged from a received module, an internal gear ring brake, a freewheel, a shift hub, an actuator and a drive shaft.

11. The device according to claim 1, having at least one brake generator.

12. The device according to claim 1, which is designed to transmit naturally provided energy to the at least one module accommodated in one of the accommodation stations and to make it available again.

13. The device according to claim 1, which is designed to transmit energy provided by at least one photovoltaic system and/or by at least one wind energy system to the at least one module accommodated in one of the accommodation stations.

14. A module comprising:
at least one mechanical energy reservoir;
at least one tension side; and
at least one release side, wherein energy is supplied to the at least one energy reservoir for storing energy in the at least one energy reservoir via the at least one tension side, and wherein energy stored in the at least one energy reservoir is withdrawn via the at least one release side.

15. The module according to claim 14, wherein the at least one mechanical energy reservoir is designed as a spring.

16. The module according to claim 14, which is designed for being accommodated in an accommodation station of a device designed for converting of energy and can be connected via a transmission of this device on the at least one tension side to a first energy converter and on the at least one release side to a second energy converter, such that it is possible to transmit energy from the first energy converter to the module and simultaneously from the module to a second energy converter.

17. The module according to claim 14, further comprising a main tension wheel and a main release wheel.

18. A method for converting and storing energy, comprising:
accommodating at least one module for storing mechanical energy is accommodated in at least one accommodation station of at least one device designed for converting energy, such that via a transmission of the at least one device for converting energy at least one module accommodated in the at least one accommodation station is connected to a first energy converter and to a second energy converter such that it is possible for energy to be transmitted simultaneously from the first energy converter to the at least one module and from the at least one module to the second energy converter.

19. The method according to claim 18, wherein at least one tension side of the at least one module is mechanically engaged with or disengaged from the transmission and in which at least one release side of the at least one module is either mechanically engaged with or disengaged from the transmission.

20. The method according to claim 18, wherein switching between at least two modules takes place via the transmission such that one of the energy converters is connected initially to at least one first module and after a switching operation to be performed by the transmission to at least one second module.

21. The method according to claim 18, wherein energy provided from the outside is stored via the first energy converter in the at least one module and energy stored in the at least one module is emitted to the outside via the second energy converter.

22. The method according to claim 18, wherein naturally provided energy is converted and stored.

23. The method according to claim 18, wherein energy is stored in at least one module in a first device, and after a transport of this at least one module from the first device to a second device energy stored in the at least one module is discharged in the second device.

24. The method according to claim 18, wherein an operation of the transmission and/or a state of at least one module is automatically checked.

25. A computer program with program code means for performing steps when the computer program is run on a computer or a corresponding calculating unit in a device for converting energy, said steps comprising:
accommodating at least one module for storing mechanical energy in at least one accommodation station of at least one device designed for converting energy, such that via a transmission of the at least one device for converting energy at least one module accommodated in the at least one accommodation station is connected to a first energy converter and to a second energy converter such that it is possible for energy to be transmitted simultaneously from the first energy converter to the at least one module and from the at least one module to the second energy converter.

26. A computer program product with program code means stored on a computer-readable data carrier for performing the steps when the computer program product is run on a computer or a corresponding calculating unit in a device for converting energy, said steps comprising:
accommodating at least one module for storing mechanical energy in at least one accommodation station of at least one device designed for converting energy, such that via a transmission of the at least one device for converting energy at least one module accommodated in the at least one accommodation station is connected to a first energy converter and to a second energy converter such that it is possible for energy to be transmitted simultaneously from the first energy converter to the at least one module and from the at least one module to the second energy converter.
